(19) United States
(12) Patent Application Publication
(10) Pub. No.: US 2011/0005006 A1
(43) Pub. Date: Jan. 13, 2011

(54) Method of Laundering Fabric Using a Compacted Laundry Detergent Composition

(75) Inventors: Alan Thomas Brooker, Newcastle upon Tyne (GB); Nigel Patrick Somerville Roberts, Newcastle upon Tyne (GB); Gregory Scot Miracle, Hamilton, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Proter & Gamble Company, Cincinnati, OH (US)

(21) Appl. No.: 12/880,340

(22) Filed: Sep. 13, 2010

Related U.S. Application Data
(63) Continuation of application No. PCT/US2010/040586, filed on Jun. 30, 2010.
(60) Provisional application No. 61/325,395, filed on Apr. 19, 2010.
(60) Provisional application No. 61/224,145, filed on Jul. 9, 2009.

(51) Int. Cl. C11D 3/39; C11D 17/08; C11D 3/395; D06L 1/20

(52) U.S. Cl. 8/137; 510/337; 510/302; 510/309

(57) ABSTRACT

The present invention relates to a method of laundering fabric comprising the step of contacting a solid laundry detergent composition comprising a bleach ingredient to water to form a wash liquor, and laundering fabric in said wash liquor, wherein the bleach ingredient has a log P_{o/w} of greater than 0, preferably greater than 1.5, even more preferably greater than 3.5, wherein the bleach ingredient is capable of generating a bleaching species having a X_{SO} of from 0.01 to about 0.30, preferably from 0.05 to about 0.25, even more preferably from about 0.10 to 0.20, wherein the laundry detergent is contacted to water in such an amount so that the concentration of laundry detergent composition in the wash liquor is from above 0 g/l to 5 g/l, and wherein from 0.01 kg to 2 kg of fabric per litre of wash liquor is dosed into said wash liquor.

### CROSS REFERENCE TO RELATED APPLICATIONS

This application is a Continuation of International Application No. PCT/US2010/040586, filed Jun. 30, 2010, which claims the benefit of U.S. Provisional Application No. 61/325,395, filed Apr. 19, 2010; and U.S. Provisional Application No. 61/224,145, filed Jul. 9, 2009.

### FIELD OF THE INVENTION

The present invention relates to a method of laundering fabric. The method exhibits good bleach performance and has an excellent environmental profile.

### BACKGROUND OF THE INVENTION

As one wishes to remove more and more chemistry from solid laundry detergent products, one must optimize the cleaning performance of what is left or suffer a severe reduction in cleaning performance. This is especially true for bleaching performance.

As one removes more and more hydrogen peroxide source, less hydrogen peroxide is available to be converted into a perhydroxy anion, and in turn (in the presence of decreasing levels of bleach activators) less peracid is available to contribute to bleaching performance. In addition to this, as one removes more and more alkalinity source, the reserve alkalinity of the detergent product is reduced, which in turn means that that the pH of the wash liquor is likely to reduce, which in turn reduces the proportion of hydrogen peroxide that exists as a perhydroxy anion.

What remains constant though is the amount of fabric typically laundered during the washing process. So less bleach is used to clean the same amount of fabric. In addition, as well as being the substrate to be cleaned, this fabric brings in its own stress on the bleaching system, namely in the form of catalase, which is present in the fabric to be laundered, and rapidly catalyzes the decomposition of hydrogen peroxide to water and oxygen, thereby reducing the performance of the bleaching system.

The inventors have found that by carefully controlling the log P_{o/w}, and X_{SO} properties of the bleaching species to be incorporated into the laundry detergent composition, one can maintain a good bleaching performance whilst at the same time compact the formulation and the bleach system.

The inventors herein provide a method of laundering fabric having a good bleach performance profile, whilst at the same time having a good environmental profile.

### SUMMARY OF THE INVENTION

The present invention relates to a method of laundering fabric as defined by the claims.

### DETAILED DESCRIPTION OF THE INVENTION

### Method of Laundering Fabric

The method of laundering fabric comprises the step of contacting a solid laundry detergent composition comprising a bleach ingredient to water to form a wash liquor, and laundering fabric in said wash liquor. The fabric may be contacted to the water prior to, or after, or simultaneous with, contacting the laundry detergent composition with water.

Typically, the wash liquor is formed by contacting the solid laundry detergent to water in such an amount so that the concentration of laundry detergent composition in the wash liquor is from above 0 g/l to 5 g/l, preferably from 1 g/l, and preferably to 4.5 g/l, or to 4.0 g/l, or to 3.5 g/l, or to 3.0 g/l, or to 2.5 g/l, or even to 2.0 g/l, or even to 1.5 g/l.

Highly preferably, the method of laundering fabric is carried out in a front-loading automatic washing machine. In this embodiment, the wash liquor formed and concentration of laundry detergent composition in the wash liquor is that of the main wash cycle. Any input of water during any optional rinsing step(s) that typically occurs when laundering fabric using a front-loading automatic washing machine is not included when determining the volume of the wash liquor. Of course, any suitable automatic washing machine may be used, although it is extremely highly preferred that a front-loading automatic washing machine is used.

It is highly preferred for the wash liquor to comprise 40 litres or less of water, preferably 35 litres or less, preferably 30 litres or less, preferably 25 litres or less, preferably 20 litres or less, preferably 15 litres or less, preferably 12 litres or less, preferably 10 litres or less, preferably 8 litres or less, or even 6 litres or less of water. Preferably, the wash liquor comprises from above 0 to 15 litres, or from 1 litre, or from 2 litres, or from 3 litres, and preferably to 12 litres, or to 10 litres, or even to 8 litres of water. Most preferably, the wash liquor comprises from 1 litre, or from 2 litres, or from 3 litres, or from 4 litres, or even from 5 litres of water.

Typically from 0.01 kg to 2 kg of fabric per litre of wash liquor is dosed into said wash liquor. Typically from 0.01 kg, or from 0.02 kg, or from 0.03 kg, or from 0.05 kg, or from 0.07 kg, or from 0.10 kg, or from 0.12 kg, or from 0.15 kg, or from 0.18 kg, or from 0.20 kg, or from 0.22 kg, or from 0.25 kg fabric per litre of wash liquor is dosed into said wash liquor.

Preferably 50 g or less, more preferably 45 g or less, or 40 g or less, or 35 g or less, or 30 g or less, or 25 g or less, or 20 g or less, or even 15 g or less, or even 10 g or less of laundry detergent composition is contacted to water to form the wash liquor.

Preferably, the laundry detergent composition is contacted to from above 0 litres, preferably from above 1 litre, and preferably to 70 litres or less of water to form the wash liquor, or preferably to 40 litres or less of water, or preferably to 35 litres or less, or preferably to 30 litres or less, or preferably to 25 litres or less, or preferably to 20 litres or less, or preferably to 15 litres or less, or preferably to 12 litres or less, or preferably to 10 litres or less, or preferably to 8 litres or less, or even to 6 litres or less of water to form the wash liquor.

### Laundry Detergent Composition

The solid laundry detergent composition comprises a bleach ingredient, and optionally other detergent ingredients. The bleach ingredient is described in more detail below.

The composition can be any solid form, for example a solid powder or tablet form, or any combination thereof. The composition may be in any unit dose form, for example a tablet or a pouch, or even a detergent sheet. However, it is extremely highly preferred for the composition to be in solid form, and it is especially preferred for the composition to be in a solid free-flowing particulate form, for example such that the composition is in the form of separate discrete particles.

The composition is a fully finished laundry detergent composition. Typically, if the composition is in free-flowing particulate form, the composition comprises a plurality of chemically different particles populations. The composition is not just a component of a laundry detergent composition that can be incorporated into a laundry detergent composition (such as an enzyme prill, or a surfactant particle, or a bleach particle), it is a fully finished laundry detergent composition. That said, it is within the scope of the present invention for an additional rinse additive composition (e.g. fabric conditioner or enhancer), or a main wash additive composition (e.g. bleach additive) to also be used in combination with the laundry detergent composition during the method of the present invention. Although, it may be preferred for no bleach additive composition is used in combination with the laundry detergent composition during the method of the present invention.

### Bleach Ingredient

Typically, the bleach ingredient has a log P_{o/w} of greater than 0, preferably greater than 0.5, preferably greater than 1.0, preferably greater than 1.5, preferably greater than 2.0, preferably greater than 2.5, preferably greater than 3.0, even more preferably greater than 3.5. The method for determining log P_{o/w} is described in more detail below.

Typically, the bleach ingredient is capable of generating a bleaching species having a X_{SO} of from 0.01 to about 0.30, preferably from 0.05 to about 0.25, even more preferably from about 0.10 to 0.20. The method for determining X_{SO} is described in more detail below. For example, bleaching ingredients having an isoquinolinium structure are capable of generating a bleaching species that has an oxaziridinium structure. In this example, the X_{SO} is that of the oxaziridinium bleaching species.

Without wishing to be bound by theory, the inventors believe that controlling the electophilicity and hydrophobicity in this above described manner enables the bleach ingredient to be delivered substantially only to areas of the fabric that are more hydrophobic, and that contain electron rich soils, including visible chromophores, that are susceptible to bleaching by highly electrophilic oxidants.

Preferably, the bleaching ingredient is catalytic. A highly preferred bleach ingredient is a bleach catalyst that is capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Suitable iminium cations and polyions include, but are not limited to, N-methyl-3,4-dihydroisoquinolinium tetrafluoroborate, prepared as described in Tetrahedron (1992), 49(2), 423-38 (see, for example, compound 4, p. 433); N-methyl-3,4-dihydroisoquinolinium p-toluene sulphonate, prepared as described in U.S. Pat. No. 5,360,569 (see, for example, Column 11, Example 1); and N-octyl-3,4-dihydroisoquinolinium p-toluene sulphonate, prepared as described in U.S. Pat. No. 5,360,568 (see, for example, Column 10, Example 3).

Suitable iminium zwitterions include, but are not limited to, N-(3-sulfopropyl)-3,4-dihydroisoquinolinium, inner salt, prepared as described in U.S. Pat. No. 5,576,282 (see, for example, Column 31, Example II); N-[2-(sulphooxy)dodecyl]-3,4-dihydroisoquinolinium, inner salt, prepared as described in U.S. Pat. No. 5,817,614 (see, for example, Column 32, Example V); 2-[3-[(2-ethylhexyl)oxy]-2-(sulphooxy)propyl]-3,4-dihydroisoquinolinium, inner salt, prepared as described in WO05/047264 (see, for example, page 18, Example 8), and 2-[3-[(2-butyloctyl)oxy]-2-(sulphooxy)propyl]-3,4-dihydroisoquinolinium, inner salt.

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulphooxy)decyl]-1,2,3,4-tetrahydroisoquinoline.

Suitable N-sulphonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61.

Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70.

Suitable N-acyl imine oxygen transfer catalysts include, but are not limited to, [N(E)]-N-(phenylmethylene)acetamide, which can be made according to the procedures described in Polish Journal of Chemistry (2003), 77(5), 577-590.

Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Example 2).

Suitable perfluoroimine oxygen transfer catalysts include, but are not limited to, (Z)-2,2,3,3,4,4,4-heptafluoro-N-(nonafluorobutyl)butanimidoyl fluoride, which can be made according to the procedures described in Tetrahedron Letters (1994), 35(34), 6329-30.

Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Example 1).

Preferably, the bleach catalyst comprises an iminium and/or carbonyl functional group and is typically capable of forming an oxaziridinium and/or dioxirane functional group upon acceptance of an oxygen atom, especially upon acceptance of an oxygen atom from a peroxyacid and/or salt thereof. Preferably, the bleach catalyst comprises an oxaziridinium functional group and/or is capable of forming an oxaziridinium functional group upon acceptance of an oxygen atom, especially upon acceptance of an oxygen atom from a peroxyacid and/or salt thereof. Preferably, the bleach catalyst comprises a cyclic iminium functional group, preferably wherein the cyclic moiety has a ring size of from five to eight atoms (including the nitrogen atom), preferably six atoms. Preferably, the bleach catalyst comprises an aryliminium functional group, preferably a bi-cyclic aryliminium functional group, preferably a 3,4-dihydroisoquinolinium functional group. Typically, the imine functional group is a quaternary imine functional group and is typically capable of forming a quaternary oxaziridinium functional group upon acceptance of an oxygen atom, especially upon acceptance of an oxygen atom from a peroxyacid and/or salt thereof.

Preferably, the bleach catalyst has a chemical structure corresponding to the following chemical formula

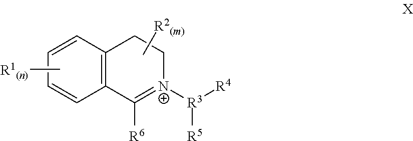

wherein: n and m are independently from 0 to 4, preferably n and m are both 0; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals; and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxys, arylcarbonyl groups, carboxyalkyl groups and amide groups; any R² may be joined together with any other of R² to form part of a common ring; any geminal R² may combine to form a carbonyl; and any two R² may combine to form a substituted or unsubstituted fused unsaturated moiety; R³ is a C₁ to C₂₀ substituted or unsubstituted alkyl; R⁴ is hydrogen or the moiety Qₜ-A, wherein: Q is a branched or unbranched alkylene, t=0 or 1 and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}—[(CR⁹R¹⁰)_{y}—O]ₖ—R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubstituted said moieties having less than 21 carbons; each G is independently selected from the group consisting of CO, SO₂, SO, PO and PO₂; R⁹ and R¹⁰ are independently selected from the group consisting of H and C₁-C₄ alkyl; R¹¹ and R¹² are independently selected from the group consisting of H and alkyl, or when taken together may join to form a carbonyl; b=0 or 1; c can =0 or 1, but c must =0 if b=0; y is an integer from 1 to 6; k is an integer from 0 to 20; R⁶ is H, or an alkyl, aryl or heteroaryl moiety; said moieties being substituted or unsubstituted; and X, if present, is a suitable charge balancing counterion, preferably X is present when R⁴ is hydrogen, suitable X, include but are not limited to: chloride, bromide, sulphate, methosulphate, sulphonate, p-toluenesulphonate, borontetraflouride and phosphate.

In one embodiment of the present invention, the bleach catalyst has a structure corresponding to general formula below:

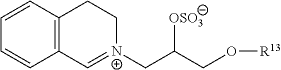

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

In another embodiment of the present invention, the bleach catalyst has a structure corresponding to general formula below or mixtures thereof.

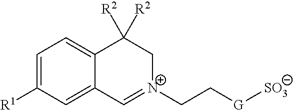

wherein: G is selected from —O—, —CH₂O—, —(CH₂)₂—, and —CH₂—. R¹ is selected from H or C₁-C₄ alkyl. Suitable C₁-C₄ alkyl moieties include, but are not limited to methyl, ethyl, iso-propyl, and tert-butyl. Each R² is independently selected from C₄-C₈ alkyl, benzyl, 2-methylbenzyl, 3-methylbenzyl, 4-methylbenzyl, 4-ethylbenzyl, 4-iso-propylbenzyl and 4-tert-butylbenzyl. Suitable C₄-C₈ alkyl moieties include, but are not limited to n-butyl, n-pentyl, cyclopentyl, n-hexyl, cyclohexyl, cyclohexylmethyl, n-heptyl and octyl.

In one aspect of the invention G is selected from —O— and —CH₂—. R¹ is selected from H, methyl, ethyl, iso-propyl, and tert-butyl. Each R² is independently selected from C₄-C₆ alkyl, benzyl, 2-methylbenzyl, 3-methylbenzyl, and 4-methylbenzyl.

In another aspect of the invention G is —CH₂—, R¹ is H and each R² is independently selected from n-butyl, n-pentyl, n-hexyl, benzyl, 2-methylbenzyl, 3-methylbenzyl, and 4-methylbenzyl.

### Source of Hydrogen Peroxide

The composition preferably comprises a source of hydrogen peroxide, preferably from above 0 wt % to 15 wt %, preferably from 1 wt %, or from 2 wt %, or from 3 wt %, or from 4 wt %, or from 5 wt %, and preferably to 12 wt % source of hydrogen peroxide. Preferably, the wash liquor comprises from above 0 g/l to 0.5 g/l hydrogen peroxide, preferably from 0.01 g/l, and preferably to 0.4 g/l, or even to 0.3 g/l, or even to 0.2 g/l, or even to 0.1 g/l. Preferably, the laundry detergent composition comprises a source of hydrogen peroxide in an amount such that during the method of the present invention from above 0 g to 1.5 g, or to 1.0 g, or to 0.8 g, or to 0.6 g, or to 0.5 g, or to 0.4 g source of hydrogen peroxide per litre of water is contacted to said water when forming the wash liquor.

Typically, the source of hydrogen peroxide comprises from 10% to 100%, by weight of the source of hydrogen peroxide, of hydrogen peroxide.

Preferred sources of hydrogen peroxide include sodium perborate in, preferably in mono-hydrate or tetra-hydrate form or mixtures thereof, sodium percarbonate. Especially preferred is sodium percarbonate. The sodium percarbonate can be in the form of a coated percarbonate particle, the particle being a physically separate and discrete particle from the other particles of the laundry detergent composition, and especially from any bleach activator or the bleach ingredient. Alternatively, the percarbonate can be in the form of a co-particle that additionally comprises a bleach activator such as tetra-ethylene diamine (TAED) and the bleach ingredient. Highly preferred, when a co-particle form is used, a bleach activator at least partially, preferably completely, encloses the source of hydrogen peroxide.

### Detersive Surfactant

The composition preferably comprises detersive surfactant, preferably from 10 wt % to 40 wt %, preferably from 12 wt %, or from 15 wt %, or even from 18 wt % detersive surfactant. Preferably, the surfactant comprises alkyl benzene sulphonate and one or more detersive co-surfactants. The surfactant preferably comprises C₁₀-C₁₃ alkyl benzene sulphonate and one or more co-surfactants. The co-surfactants preferably are selected from the group consisting of C₁₂-C₁₈ alkyl ethoxylated alcohols, preferably having an average degree of ethoxylation of from 1 to 7; C₁₂-C₁₈ alkyl ethoxylated sulphates, preferably having an average degree of ethoxylation of from 1 to 5; and mixtures thereof. However, other surfactant systems may be suitable for use in the present invention.

Suitable detersive surfactants include anionic detersive surfactants, nonionic detersive surfactants, cationic detersive surfactants, zwitterionic detersive surfactants, amphoteric detersive surfactants and mixtures thereof.

Suitable anionic detersive surfactants include: alkyl sulphates; alkyl sulphonates; alkyl phosphates; alkyl phosphonates; alkyl carboxylates; and mixtures thereof. The anionic surfactant can be selected from the group consisting of: C₁₀-C₁₈ alkyl benzene sulphonates (LAS) preferably C₁₀-C₁₃ alkyl benzene sulphonates; C₁₀-C₂₀ primary, branched chain, linear-chain and random-chain alkyl sulphates (AS), typically having the following formula:

CH₃(CH₂)xCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

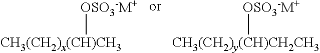

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants include: linear or branched, substituted or unsubstituted alkyl benzene sulphonate detersive surfactants, preferably linear C₈-C₁₈ alkyl benzene sulphonate detersive surfactants; linear or branched, substituted or unsubstituted alkyl benzene sulphate detersive surfactants; linear or branched, substituted or unsubstituted alkyl sulphate detersive surfactants, including linear C₈-C₁₈ alkyl sulphate detersive surfactants, C₁-C₃ alkyl branched C₈-C₁₈ alkyl sulphate detersive surfactants, linear or branched alkoxylated C₈-C₁₈ alkyl sulphate detersive surfactants and mixtures thereof; linear or branched, substituted or unsubstituted alkyl sulphonate detersive surfactants; and mixtures thereof.

Preferred alkoxylated alkyl sulphate detersive surfactants are linear or branched, substituted or unsubstituted C₈₋₁₈ alkyl alkoxylated sulphate detersive surfactants having an average degree of alkoxylation of from 1 to 30, preferably from 1 to 10. Preferably, the alkoxylated alkyl sulphate detersive surfactant is a linear or branched, substituted or unsubstituted C₈₋₁₈ alkyl ethoxylated sulphate having an average degree of ethoxylation of from 1 to 10. Most preferably, the alkoxylated alkyl sulphate detersive surfactant is a linear unsubstituted C₈₋₁₈ alkyl ethoxylated sulphate having an average degree of ethoxylation of from 3 to 7.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Suitable cationic detersive surfactants include: alkyl pyridinium compounds; alkyl quaternary ammonium compounds; alkyl quaternary phosphonium compounds; alkyl ternary sulphonium compounds; and mixtures thereof. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable non-ionic detersive surfactant can be selected from the group consisting of: C₈-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 10, more preferably from 3 to 7.

### Polymeric Carboxylate

The composition preferably comprises polymeric carboxylate. It may be preferred for the composition to comprise at least 5 wt % or at least 6 wt %, or at least 7 wt %, or at least 8 wt %, or even at least 9 wt %, by weight of the composition, of polymeric carboxylate. The polymeric carboxylate can sequester free calcium ions in the wash liquor. The carboxylate polymers can also act as soil dispersants and can provide an improved particulate stain removal cleaning benefit. Preferred polymeric carboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

### Zeolite Builder

Preferably, the composition comprise from 0 wt % to 10 wt % zeolite builder, preferably to 8 wt %, or to 6 wt %, or to 4 wt %, or even to 2 wt % zeolite builder. The composition may even be substantially free of zeolite builder, substantially free means “no deliberately added”. Typical zeolite builders are zeolite A, zeolite P and zeolite MAP.

### Phosphate Builder

Preferably, the composition comprise from 0 wt % to 10 wt % phosphate builder, preferably to 8 wt %, or to 6 wt %, or to 4 wt %, or even to 2 wt % phosphate builder. The composition may even be substantially free of phosphate builder, substantially free means “no deliberately added”. A typical phosphate builder is sodium tri-polyphosphate

### Source of Carbonate

The composition may comprise a source of carbonate. Preferred sources of carbonate include sodium carbonate and/or sodium bicarbonate. A highly preferred source of carbonate is sodium carbonate. Sodium percarbonate may also be used as the source of carbonate.

### Bleach Activator

Preferably, the composition comprises a bleach activator. Suitable bleach activators are compounds which when used in conjunction with a hydrogen peroxide source leads to the in situ production of the peracid corresponding to the bleach activator. Various non limiting examples of bleach activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetylethylenediamine (TAED) activators are typical, and mixtures thereof can also be used. See also U.S. Pat. No. 4,634,551 for other typical bleaches and activators useful herein. Another suitable bleach activator is decanoyloxybenzenecarboxylic acid (DOBA).

Highly preferred amido-derived bleach activators are those of the formulae:

R¹N(R⁵)C(O)R²C(O)L or R¹C(O)N(R⁵)R²C(O)L

wherein as used for these compounds R¹ is an alkyl group containing from about 6 to about 12 carbon atoms, R² is an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the hydroperoxide anion. A preferred leaving group is oxybenzenesulfonate.

Preferred examples of bleach activators of the above formulae include (6-octanamido-caproyl)oxybenzenesulfonate, (6-nonanamidocaproyl)oxybenzenesulfonate, (6-decanamido-caproyl)oxybenzenesulfonate, and mixtures thereof as described in U.S. Pat. No. 4,634,551, incorporated herein by reference.

Another class of bleach activators comprises the benzoxazin-type activators disclosed by Hodge et al in U.S. Pat. No. 4,966,723, issued Oct. 30, 1990, incorporated herein by reference. A highly preferred activator of the benzoxazin-type is:

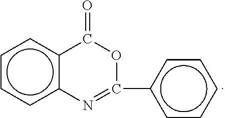

Still another class of preferred bleach activators includes the acyl lactam activators, especially acyl caprolactams and acyl valerolactams of the formulae:

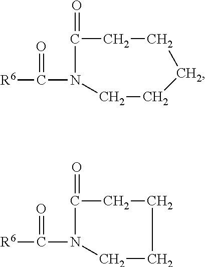

wherein as used for these compounds R⁶ is H or an alkyl, aryl, alkoxyaryl, or alkaryl group containing from 1 to about 12 carbon atoms. Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. See also U.S. Pat. No. 4,545,784, issued to Sanderson, Oct. 8, 1985, incorporated herein by reference, which discloses acyl caprolactams, including benzoyl caprolactam, adsorbed into sodium perborate. Highly preferred bleach activators are nonanoyloxybenzene sulfonate (NOBS) and/or tetraacetylethylenediamine (TAED).

It is highly preferred for a large amount of bleach activator relative to the source of hydrogen peroxide to be present in the laundry detergent composition. Preferably, the weight ratio of bleach activator to source of hydrogen peroxide present in the laundry detergent composition is at least 0.5:1, at least 0.6:1, at least 0.7:1, 0.8:1, preferably at least 0.9:1, or 1.0:1.0, or even 1.2:1 or higher.

### Chelant

The composition may comprise a chelant. Suitable chelants include diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). Preferably the ethylene diamine-N′N′-disuccinic acid is in S′S′ enantiomeric form.

### Other Detergent Ingredients

The composition typically comprises other detergent ingredients. Suitable detergent ingredients include: transition metal catalysts; enzymes such as amylases, carbohydrases, cellulases, laccases, lipases, bleaching enzymes such as oxidases and peroxidases, proteases, pectate lyases and mannanases; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; perfumes such as perfume microcapsules; soap rings; aesthetic particles; dyes; fillers such as sodium sulphate, although it is preferred for the composition to be substantially free of fillers; silicate salt such as sodium silicate, including 1.6 R and 2.0 R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose; and any combination thereof.

Method of Determining Log P_{o/w}

Log P_{o/w} is determined according to the method found in Brooke, D. N., Dobbs, A. J., Williams, N, Ecotoxicology and Environmental Safety (1986) 11(3): 251-260.

Method of Determining Xso

The parameter Xso is determined according to the method described in Adam, W., Haas, W., Lohray, B. B. Journal of the American Chemical Society (1991) 113(16) 6202-6208.

### EXAMPLES

30 g of the following free-flowing particulate laundry detergent compositions were used to wash 3.0 kg fabric in a Miele 3622 front-loading automatic washing machine (13 L wash liquor volume, short wash cycle (1 h, 25 mins), 30° C. wash temperature).

| Ingredient | Composition A | | Composition B | | Composition C | | Composition D | |
|---|---|---|---|---|---|---|---|---|
| Bleaching ingredient* | 0.05 | wt % | 0.1 | wt % | 0.05 | wt % | 0.01 | wt % |
| Tetraacetylethylenediamine | 10.0 | wt % | 7.5 | wt % | 12 | wt % | 10 | wt % |
| (TAED) | | | | | | | | |
| Sodium percarbonate (PC3) | 10.0 | wt % | 15 | wt % | 12 | wt % | 10 | wt % |
| hydroxyethane di[methylene | 0.5 | wt % | 0.5 | wt % | 0.1 | wt % | 0.8 | wt % |
| phosphonic acid] (HEDP) | | | | | | | | |
| C₁₁₋₁₃ alkyl benzene sulphonate | 20.0 | wt % | 25 | wt % | 15 | wt % | 20 | wt % |
| (LAS) | | | | | | | | |
| Ethoxylated C₁₂₋₁₅ alkyl sulphate | 5.0 | wt % | 5 | wt % | 10 | wt % | 7 | wt % |
| having average degree of | | | | | | | | |
| ethoxylation of between 1 and 3 | | | | | | | | |
| (AE₁₋₃S) | | | | | | | | |
| mono-C₈₋₁₀ alkyl mono- | 1.0 | wt % | 0.5 | wt % | 2.0 | wt % | 1.5 | wt % |
| hydroxyethyl di-methyl quaternary | | | | | | | | |
| ammonium chloride | | | | | | | | |
| Sodium sulphate | 3.0 | wt % | 0 | wt % | 0 | wt % | 1 | wt % |
| Sodium carbonate | 25.0 | wt % | 20 | wt % | 30 | wt % | 22 | wt % |
| Sodium silicate (1.6R) | 2.0 | wt % | 0 | wt % | 0 | wt % | 1.0 | wt % |
| Zeolite 4A | 2.0 | wt % | 0 | wt % | 0 | wt % | 1.0 | wt % |
| Florescent whitening agent | 0.5 | wt % | 0.5 | wt % | 0.1 | wt % | 0.5 | wt % |
| Silicone suds suppressor | 0.05 | wt % | 0.05 | wt % | 0.1 | wt % | 0.05 | wt % |
| Enzymes (protease, amylase, | 2.0 | wt % | 1.0 | w % | 1.5 | wt % | 2.0 | wt % |
| cellulase and mixtures thereof) | | | | | | | | |
| Co-polymer of maleic acid and | 8.0 | wt % | 10 | wt % | 12 | wt % | 10 | wt % |
| acrylic acid (MA/AA) | | | | | | | | |
| Polyethylene oxide with pendant | 2.0 | wt % | 4.0 | wt % | 1.0 | wt % | 1.5 | wt % |
| polyvinylacetate groups | | | | | | | | |
| Carboxymethyl cellulose (CMC) | 1.0 | wt % | 2.0 | wt % | 1.0 | wt % | 1.2 | wt % |
| Repel-o-tex | 0.1 | wt % | 0 | wt % | 0.2 | wt % | 0.15 | wt % |
| Moisture & Miscellaneous | to 100 | wt % | to 100 | wt % | to 100 | wt % | to 100 | wt % |

*bleach ingredient is sulphuric acid mono-[2-(3,4-dihydro-isoquinolin-2-yl)-1-(2-butyl-octyloxymethyl)-ethyl] ester, internal salt.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric comprising the step of contacting a solid laundry detergent composition comprising a bleach ingredient to water to form a wash liquor, and laundering fabric in said wash liquor,
wherein the bleach ingredient has a log P_{o/w}, of greater than about 0,
wherein the bleach ingredient is capable of generating species having a X_{SO} of from about 0.01 to about 0.30,
wherein the laundry detergent is contacted to water in such an amount so that the concentration of the laundry detergent composition in the wash liquor is from above 0 g/l to 5 g/l,
and wherein from 0.01 kg to 2 kg of fabric per litre of wash liquor is dosed into said wash liquor.

2. A method according to claim 1, wherein the bleach ingredient has a log P_{o/w} of from about 3.5 to about 5.0.

3. A method according to claim 1, wherein the bleach ingredient is capable of generating a bleaching species having a X_{SO} of from about 0.10 to about 0.15.

4. A method according to claim 1, wherein the bleach ingredient is a bleach catalyst having a structure corresponding to general formula below: 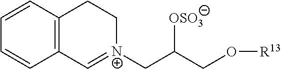
wherein R¹³ is a branched alkyl group containing from three to about 24 carbon atoms (including the branching carbon atoms) or a linear alkyl group containing from one to about 24 carbon atoms.

5. A method according to claim 4, wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

6. A method according to claim 1, wherein the composition is in free-flowing particulate form.

7. A method according to claim 1, wherein the composition comprises from above about 0 wt % to about 15 wt % source of hydrogen peroxide, and wherein from about 0.1 g to about 1.5 g source of hydrogen peroxide per litre of water is contacted to said water when forming said wash liquor.

8. A method according to claim 1, wherein the composition comprises:
(a) detersive surfactant;
(b) carboxylate polymer;
(c) less than about 10 wt % zeolite builder:
(d) less than about 10 wt % phosphate builder;
(e) optionally another detergent ingredient

9. A method according to claim 1, wherein about 40 g or less of laundry detergent composition is contacted to water to form the wash liquor.

10. A method according to claim 1, wherein the laundry detergent composition is contacted to about 15 litres or less of water to form the wash liquor.

11. A method according to claim 1, wherein the laundry detergent is contacted to water in such an amount so that the concentration of laundry detergent composition in the wash liquor is from about 1 g/l to about 4 g/1.

12. A method according to claim 1, wherein at least about 0.2 kg fabric per litre of wash liquor is dosed into said wash liquor.

13. A method according to claim 1, wherein the method is carried out using a front-loading automatic washing machine.

14. A laundry detergent composition suitable for use in the method according to claim 1, wherein the composition comprises:
(a) detersive surfactant;
(b) bleach ingredient having a log P_{o/w}, of greater than about 0, and being capable of generating a bleaching species having a X_{SO} of from about 0.01 to about 0.30,
(c) bleach activator
(d) source of hydrogen peroxide
(e) from about 0 wt % to about 10 wt % zeolite builder;
(f) from about 0 wt % to about 10 wt % phosphate builder;
wherein the weight ratio of bleach activator to source of hydrogen peroxide is at least about 0.5:1.
